(19) United States
(12) Patent Application Publication
(10) Pub. No.: US 2015/0058135 A1
(43) Pub. Date: Feb. 26, 2015

(54) OPTIMIZING AN ASSORTMENT AND ALLOCATION OF GROUPS OF ITEMS

(71) Applicant: Birchbox, Inc., New York, NY (US)

(72) Inventors: Benjamin Kelly, Brooklyn, NY (US); Elisabeth Crawford, Brooklyn, NY (US)

(21) Appl. No.: 14/463,892

(22) Filed: Aug. 20, 2014

Related U.S. Application Data
(60) Provisional application No. 61/868,378, filed on Aug. 21, 2013.

(51) Int. Cl. G06Q 30/02

(52) U.S. Cl. CPC G06Q 30/0269
USPC 705/14.66

(57) ABSTRACT

A server computer system determines an initial configuration of group types of items based on an initial set of constraints. The initial set of constraints pertains to item data for the items and user data for a plurality of users. The system modifies the initial configuration to satisfy one or more rules pertaining to the initial set of constraints to create an optimal configuration of group types. The one or more rules include at least one rule pertaining to eligibility of individual users of the plurality of users to be assigned to one of the group types. The system allocates one of the group types of the optimal configuration of group types to corresponding individual users of the plurality of users and provides data describing the optimal configuration of group types and the allocating of one of the group types to the corresponding individual users to a system.

### RELATED APPLICATIONS

This patent application claims the benefit under 35 U.S.C. §119(e) of U.S. Provisional Application No. 61/868,378 filed Aug. 21, 2013, which is herein incorporated by reference.

### TECHNICAL FIELD

The present disclosure relates to groups of items and, more particularly, to a technique of optimizing an assortment and allocation of groups of items to a set of users.

### BACKGROUND

Items can be assorted in various ways. For example, in the retail industry, sets of related products may be displayed together on a store shelf or in a window display. An assortment is a partition of products into sets. For example, an assortment of products on a retail store shelf may be one that contains the widest variety of brands within a given product category. For example, products relating to sporting goods and various brands of sporting goods products may be grouped together in a particular section of a retail store. Traditional assorting solutions may group products for display based on trends in the market, historical sales data of the merchandise, price, etc. Conventional assorting solutions, however, typically do not take into account the combination of individual consumer preferences, individual consumer eligibility to use a product, and inventory levels.

### BRIEF DESCRIPTION OF THE DRAWINGS

The present disclosure will be understood more fully from the detailed description given below and from the accompanying drawings of various implementations of the disclosure.

FIG. 1 is a diagram illustrating an example of creating groups of items and allocating the groups of items to users, in accordance with one or more aspects of the present disclosure.

FIG. 2 illustrates example system architecture, in accordance with one or more aspects of the present disclosure.

FIG. 3 is flow diagram of a method for creating groups of items and allocating the groups of items to users, in accordance with one or more aspects of the present disclosure.

FIG. 4 is flow diagram of a method for determining a solution for an optimal configuration of group types based on constraints, in accordance with one or more aspects of the present disclosure.

FIG. 5 is a block diagram of an example computer system that may perform one or more of the operations described herein in accordance with one or more aspects of the present disclosure.

### DETAILED DESCRIPTION

A system and method for creating groups of items and allocating the groups of items to users is described, according to various implementations of the present disclosure. For brevity and simplicity, a product is used as an example of an item throughout the present disclosure. In one implementation, a product is a sample-sized version of a product. A sample-sized version can be a version that is not available for purchase. In another implementation, a product is a full-sized version that is available for purchase.

Products can include, and are not limited to, consumer products, business products, etc. Business products can be sold to businesses and can be used to produce other products. Examples of consumer products can include, and are not limited to, convenience products, shopping products, specialty products, unsought products, etc. Products can include media items. Examples of a media item can include, and are not limited to, digital video, digital movies, digital photos, digital music, website content, social media updates, electronic books (ebooks), electronic magazines, digital newspapers, digital audio books, electronic journals, web blogs, real simple syndication (RSS) feeds, electronic comic books, software applications, etc. A media item can be a media item consumed via the Internet and/or via an application. For brevity and simplicity, skincare products, hair products, fragrance products, makeup products, and nail products are used as examples of products throughout this document.

One or more products can be provided to users. In one implementation of the present disclosure, the users subscribe to a service that provides one or more products to the subscribers. For example, a service provider can provide a set of products to users on a monthly basis. For example, the set of products may include five products, which may be sample-sized versions of the products and/or full-sized versions of the products. For example, the set may include one hair product, one nail product, one skincare product, one cosmetic product, and one fragrance product. In another example, the set may include a sample of a digital children's book, a sample of a digital science fiction book, a sample of a digital song, a sample of an audio book, and a sample of an online article.

In another example, implementations of the present disclosure create an optimal assortment and allocation of physical media items for users. For example, one implementation of the present disclosure sends a group of samples of books, music, etc. to users on a monthly basis based on user preferences and/or user eligibility. For example, users of a particular age group may be eligible to receive only rated G (General) media. In another example, users may be eligible to receive media in only English.

The service provider can provide sets of products to subscribers. For example, if there are 300,000 subscribers, the service provider may create 300,000 sets of products. Traditional assorting solutions may, in the least efficient manner, provide every subscriber with a custom and different set of products, which can be costly for the service provider. Implementations of the present disclosure create an optimal configuration of groups of products for the users based on rules (e.g., business rules, quality rules, eligibility rules, etc.) and user preferences. An optimal configuration can be, for example, a configuration that includes the fewest number of various types of product sets of consistent quality, maximizes the number of purchases of full-sized products, maximizes subscriber retention, and/or maximizes user feedback for the products received. Implementations of the present disclosure take into account individual user preferences and individual user eligibility to use a product.

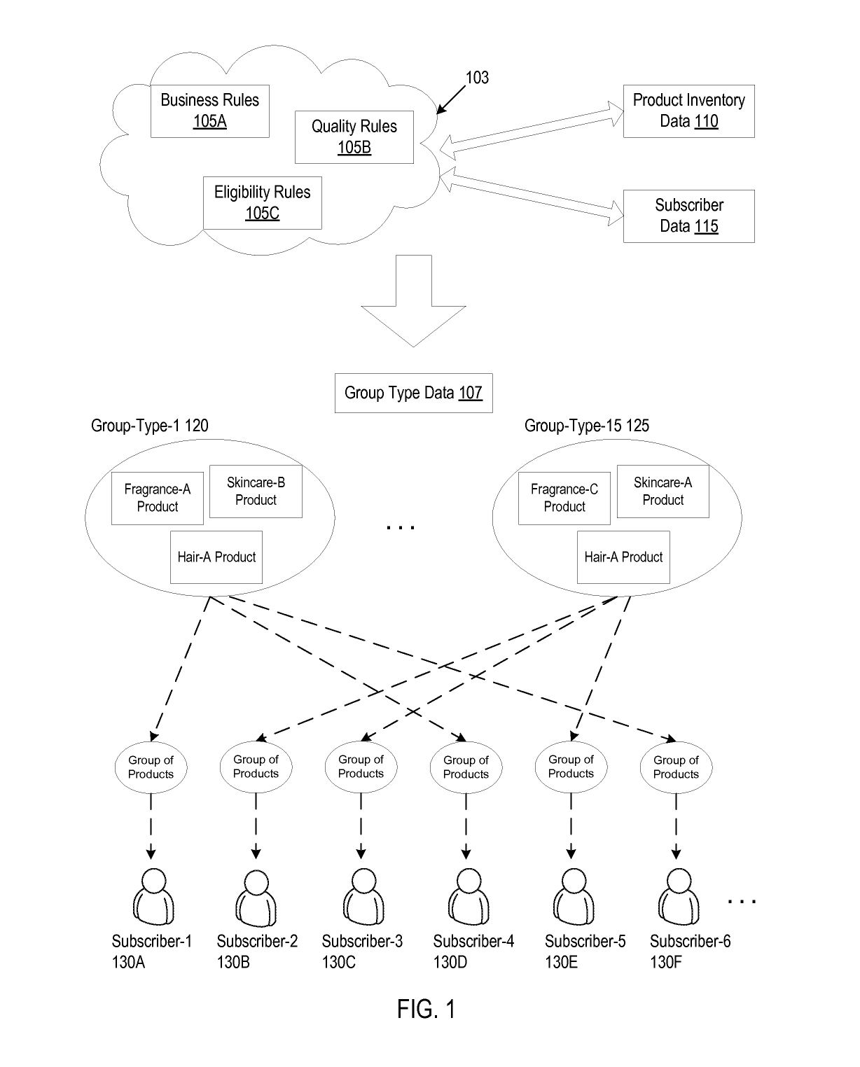

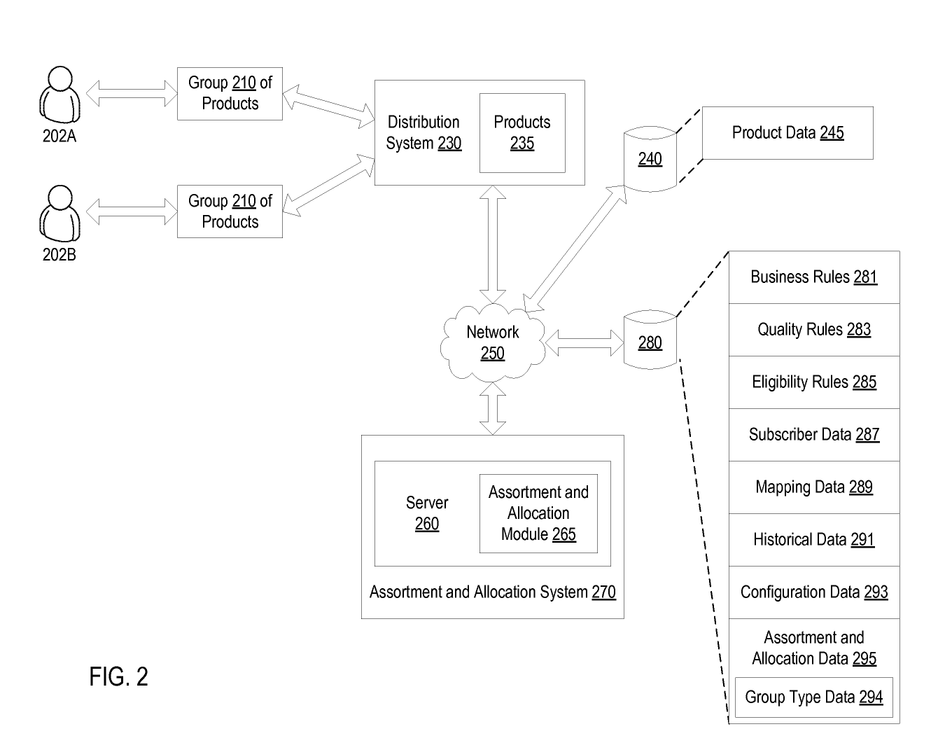

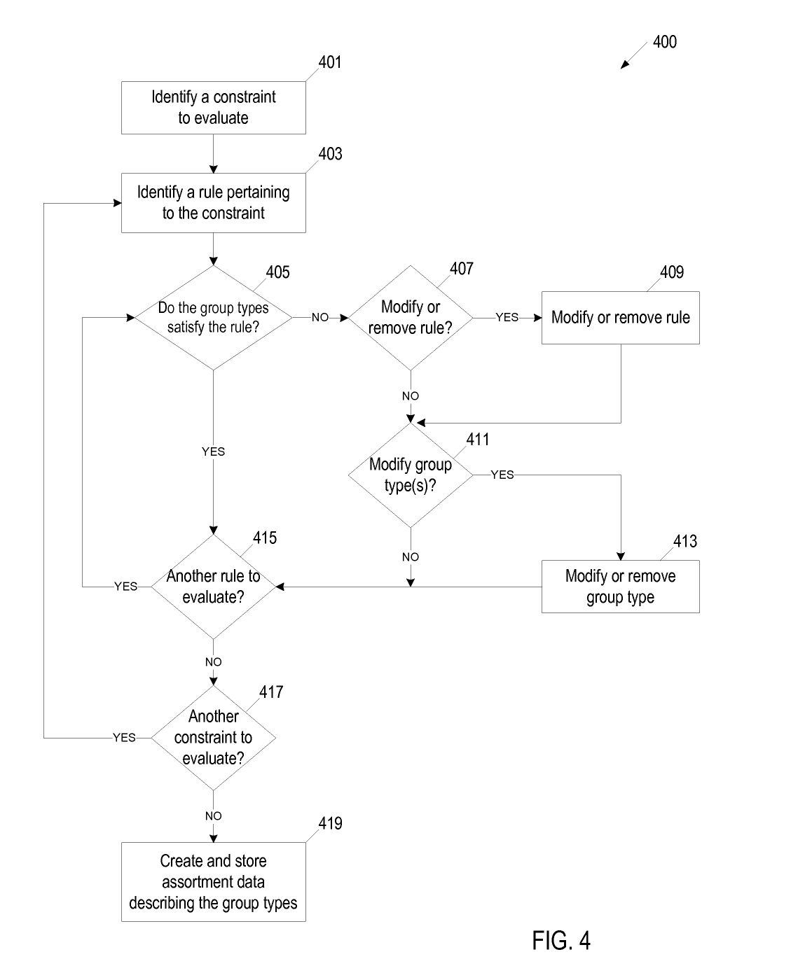

FIG. 1 illustrates an example of assorting and allocating groups of items for users (e.g., subscribers), in accordance with one or more implementations of the present disclosure. For example, a service provider may have thousands of subscribers and may have an inventory of hundreds of different types of products. For brevity and simplicity, six subscribers 130A-F are illustrated in FIG. 1. An assortment and allocation system, which is described in greater detail below in conjunction with FIG. 2, can apply one or more constraints 103 to product inventory data 110 and subscriber data 115 to determine an optimal configuration of groups of products to service the subscribers 130A-F. The constraints 103 can be represented by one or more sets of rules 105 (e.g., business rules, quality rules, mapping rules, eligibility rules, etc.), as described in greater detail below in conjunction with FIG. 2 and FIG. 4. The product inventory data 110 describes an inventory of products. In one implementation, the assortment and allocation system has access to an unlimited supply of the products pertaining to the inventory data 110 to allow the assortment and allocation system to produce an optimal configuration where each subscriber receives a “best” set of products. In another implementation, the inventory is a limited inventory of products, and the assortment and allocation system can take into account the limited inventory of products, as described by the product inventory data 110, to determine an optimal configuration of groups of products to service the subscribers.

Unlike traditional assorting solutions, which may create a different group of products for each user, the assortment and allocation system can determine the minimum number of groups of products that should be used to service the subscribers 130A-F to provide an efficient assorting solution. The “groups of products” are hereinafter also referred to as “group types”. The minimum number of group types can represent a minimum number of different group types that should be used to service the subscribers based on, for example, user eligibility to use a product and/or user preferences.

The assortment and allocation system can determine the minimum number of group types by assorting the products into an optimal (e.g., minimal) number of groups to best match subscriber traits, which can indicate subscriber eligibility to use a product. For example, subscribers that have facial hair may receive a group of products that includes shaving cream. In another example, subscribers that have color treated hair may receive a group of products that includes shampoo for color treated hair. For example, the assortment and allocation system may use the rules 105 (e.g., business rules, quality rules, and eligibility rules), product inventory data 110, and subscriber data 115 to determine that the minimum number of groups types to service subscribers is 15 group types (e.g., Group-Type-1 120 to Group-Type-15 125).

The assortment and allocation system can determine from the rules 105 (e.g., eligibility rules) and subscriber data 115 that Subscriber-1 130A, Subscriber-4 130D, and Subscriber-6 130F should receive a group of products of Group-Type-1 120. In another example, the assortment and allocation system can determine from the rules 105 and subscriber data 115 that Subscriber-2 130B, Subscriber-3 130C, and Subscriber-5 130F should receive a group of products of Group-Type-15 125.

The assortment and allocation system can create group type data 107 for each group type to describe the one or more item categories (e.g., product categories) and the one or more item sub-categories (e.g., product sub-categories) to be included in a particular group type. The categories can be user (e.g., system administrator) defined and configurable. For example, product categories can include, and are not limited to, fragrance, skincare, hair, and cosmetics. A product sub-category can further classify a product category. For example, sub-categories for the hair category can include various hair types based on texture, length, style, treatment, etc. For example, sub-categories for the hair categories can include, and are limited to, color-treated hair, dry hair, long hair, short hair, straight hair, curly hair, etc.

The group type data 107 for a corresponding group type (e.g., Group-Type-1 120, Group-Type-15 125) can define the number of products to be included in the group type, the product categories/sub-categories for the group type, and the quantity for each product category/sub-category for the group type. For example, group type data 107 for Group-Type-1 may define the group to include 5 products, which include one fragrance product for women, two skincare products for normal skin, and two hair products for color-treated hair.

In one implementation of the present disclosure, each of the different group types include at least one product sub-category that is different from the product sub-categories in other group types. For example, the assortment and allocation system may determine from the rules 105 (e.g., business rules) that each of the 15 different group types (e.g., Group-Type-1 120 to Group-type-15 125) should include at least one product sub-type that is different from the other product sub-types in the other group types. For example, Group-Type-1 120 may describe a group of products that includes Fragrance-Product-A, Skincare-B, and Hair-Product-A. A different group type, such as Group-Type-15 125, may describe a group of products that includes Fragrance-Product-C, Skincare-Product-A, and Hair-Product-A.

FIG. 2 illustrates example system architecture 200, in accordance with one or more aspects of the present disclosure. The system architecture 200 can include an assortment and allocation system 270 that communicates to a distribution system 230 over one or more networks 250. The one or more networks 250 can include one or more public networks (e.g., the Internet), one or more private networks (e.g., a local area network (LAN) or one or more wide area networks (WAN)), one or more wired networks (e.g., Ethernet network), one or more wireless networks (e.g., an 802.11 network or a Wi-Fi network), one or more cellular networks (e.g., a Long Term Evolution (LTE) network), routers, hubs, switches, server computers, and/or a combination thereof. In one implementation, some components of architecture 200 are not directly connected to each other. In one implementation, architecture 200 includes separate networks 250.

The assortment and allocation system 270 can include one or more computing devices (e.g., servers 260), data stores, networks, software components, and/or hardware components. The server 260 can be one or more computing devices (e.g., a rackmount server, a server computer, etc.). In one implementation, the server 260 is included in the distribution system 230. In another implementation, the server 260 is separate from the distribution system 230, but may communicate (e.g., exchange data with) the distribution system 230.

The server 260 can include an assortment and allocation module 265 to create an optimal assortment of products and an optimal allocation of the assortment of products to subscribers 202A,B, while taking into account an inventory of products, subscriber data 287, and rules (e.g., business rules 281, quality rules 283, eligibility rules 285). In one implementation, the inventory is a limited inventory of products. An assortment is a partition of a subset of products 235 into sets. There can be a collection of distinct products 235, a subset of which is to be grouped together into distinct groups 210 of particular group types. The assignment of products 235 to groups 210 is hereinafter referred to as assorting and/or an assortment.

The assortment and allocation module 265 can use one or more sets of rules (e.g., business rules 281, quality rules 283, and eligibility rules 285) to create various types of groups 210 and to determine the number of instances that should be created for each group type. The assortment and allocation module 265 can create group type data 294 for each group type. The group type data 294 for a corresponding group type can define the number of products to be included in the group type, the product categories and product sub-categories for the group type, and the quantity for each product category and product sub-category for the group type.

The rules can be stored in a data store 280. In one implementation, the allocation and assortment module 265 determines an optimal configuration of group types based on the rules, the subscribers 202A,B, and the product inventory, which can be included as part of product data 245. The data stores 240,280 can store subscriber data 287 and product data 245. The product data 245 can describe an inventory (e.g. limited inventory) of products, which the assortment and allocation module 265 can take into account as part of a rule (e.g., business rule 281) to determine an optimal configuration of group types to service subscribers 202A,B.

In one implementation, the assortment and allocation module 265 formulates a problem of determining an optimal configuration of group types as a constrained mixed integer linear program. A mixed-integer program is the minimization or maximization of a linear function subject to linear constraints over integer variables. Examples of constraints can include, and are not limited to, the number of subscribers, the product inventory, subscriber preferences, subscriber eligibility, business objectives, etc. The constraints can be expressed with rules (e.g., business rules 281, quality rules 283, eligibility rules 285, etc.). The configuration data 293 can specify the constraints that should be used by the assortment and allocation module 265. For example, there may be two constraints (i) that every group instance meets certain rules and simultaneously, (ii) that every subscriber be allocated a group instance for which the subscriber is eligible. The configuration data 293 can be stored in data store 280. The configuration data 293 can be configurable and/or user-defined.

Examples of business rules 281 can be, for example, and not limited to, a rule limiting the individual groups 210 to a certain number of products 235, a rule that specifies the category of products 235 in each group 210, a rule that specifies a range of products per category for each group type, a range of the number of products for each group type, and a rule that specifies a range of products with a given product attribute (e.g., packaging type, container type, cost, etc.) in each group type. For example, business rules 281 may be that each group type contains five products, that each group 210 includes at least one skincare product for oily skin, at least one hair product for hair that is not color-treated, and at least one fragrance product for men, that each group 210 contain no more than two products of a certain weight, etc.

A quality rule 283 is a rule pertaining to, for example, the quality of a group of products (e.g., group type), individual products, etc. A quality rule 283 can be based on a quality score. An example of a quality rule 283 can include, and is not limited to, a rule specifying that the various group types should have quality scores within a certain range of each other. The range between quality scores can be specified in the configuration data 293. For example, there may be five group types (e.g., Group-Type-1, Group-Type-2, Group-Type-3, Group-Type-4, and Group-Type-5). A quality rule 283 may be that the quality scores for the five group types should be within 10% of each other.

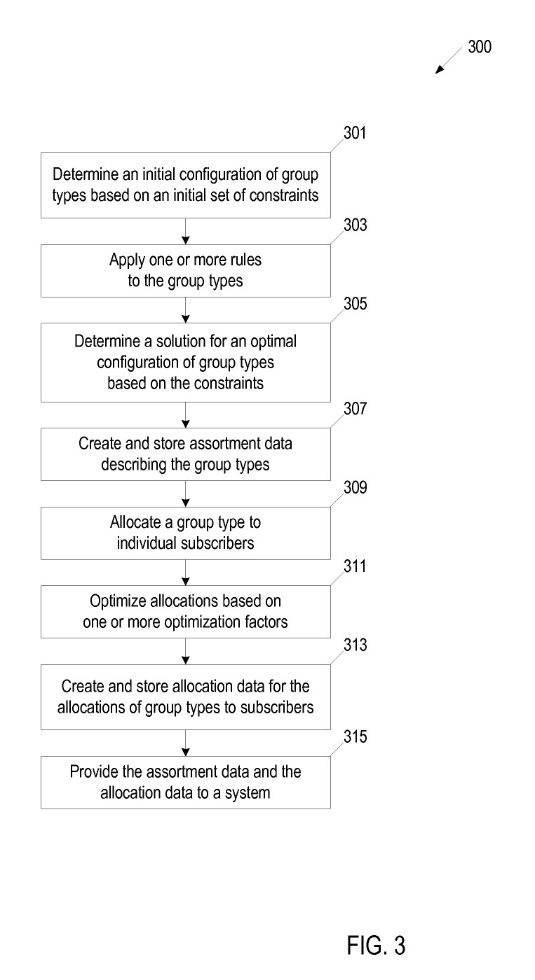

The allocation and assortment module 265 can generate quality scores for the various group types. A quality score can represent the quality of a group of products (e.g., group type), individual products, etc. The allocation and assortment module 265 can determine the quality scores for the various group types using factors that may be specified in the configuration data 293. Examples of factors can include, and are not limited to, the weight of the products, the cost of the products, the size-impression of the products, the user ratings of the products, estimates of user ratings based on prior behavioral data, etc. The product data 245 can store the information for the factors for the products 235. The allocation and assortment module 265 can use the product data 245 to determine the quality scores for the group types. One implementation of determining quality scores is described in greater detail below in conjunction with FIG. 3.

An eligibility rule 285 is a rule pertaining whether individual users (e.g., subscribers 202A,B) are eligible or ineligible to receive groups 210 of group types containing certain products 235. The constraints described by the eligibility rules 285 can be at the subscriber-product-level. For example, an eligibility rule 285 may be that a subscriber 202A,B may be ineligible for a group 210 if that group 210 contains one or more products 235 for which the subscriber 202A,B is ineligible (e.g. based on product attributes, or subscriber having already purchased the product, etc.). For example, if a subscriber 202A has color-treated hair, then the subscriber 202A is not eligible, based on an eligibility rule 285, to receive a group 210 of products having a group type that contains hair products that are not for color-treated hair. In another example, if a subscriber 202B does not have facial hair, then the subscriber 202B is ineligible, based on an eligibility rule 285, to receive a group of products having a group type that contains a men's beard-grooming product. In another example, if the subscriber 202B has a beard or mustache, then the subscriber 202B is eligible, based on an eligibility rule 285, to receive a group of products having a group type that contains a men's facial shaving product. Examples of other eligibility rules 285 can include, and are not limited to, each subscriber 202A,B should receive an instance of one group type, each subscriber 202A,B should receive an instance of a group type which the subscriber is eligible to receive, a subscriber 202A,B should not receive any group type that contains a product which the subscriber may have previously received, etc. The server 260 can use historical data 291 that is stored in the data store 280 to determine which subscribers 202A,B have already received which products 235.

The products 235 can have attributes that describe parameters of the products. The product attributes can describe for example, and are not limited to, the product category (e.g., hair product, fragrance product, skincare product, etc.), whether the product is for men or women, whether the product is for a particular age group either explicitly or implicitly through attributes such as ‘suitable for trendy people’, whether the product is for a particular age geography, whether the product is for a particular climate, whether the product is related to particular types of skin types, whether the product is related to particular types of hair types, etc. The product attributes can be stored as part of the product data 245. The product attributes can be user (e.g., system administrator) defined.

The subscribers 202A,B can have traits that describe the individual subscribers. The subscriber traits for a subscriber can describe for example, and are not limited to, the gender of the subscriber, the age group associated with the subscriber, a geography associated with the subscriber, the skin type associated with the subscriber, the hair type associated with the subscriber, etc. The subscriber traits can be stored as part of the subscriber data 287 in the data store 280. The subscriber traits can be associated with a period of time. For example, the configuration of group types may be determined on a monthly interval, and at a given month the subscriber data 287 can describe the subscriber traits at that month. The subscriber traits can be user (e.g., subscriber) defined. The subscriber data 287 can also include user preferences of the corresponding subscriber 202A,B. For example, the subscriber data 287 for Jane Doe may include blue as Jane Doe's favorite color.

The assortment and allocation system 270 can communicate with one or more systems and/or can include one or more systems to collect account information, personal information, and/or demographic information pertaining to groups of users (e.g., age of user groups, geography (e.g., country, state, city) of user groups) and can store the information in one or more data stores (e.g., hard disks, memories, databases, etc.) (e.g., data stores 240,280). In situations in which the implementations discussed herein collect personal information and/or demographic about users, or may make use of personal information and/or demographic information, the user (e.g., subscriber 202A,B) may be provided with an opportunity to control whether the assortment and allocation system 270 is allowed collect the information (e.g., information about a user's social network, social actions or activities, profession, a user's preferences, or a user's current location), or to control whether and/or how to receive content from the one or more systems that may be more relevant to the user. In addition, certain data may be treated in one or more ways before it is stored or used, so that personally identifiable information is removed. Thus, the user may have control over how, when, and what type of information is collected about the user and used by the assortment and allocation system 270.

The assortment and allocation module 265 can include mapping data 289. The mapping data 289 can map the product attributes in the product data 245 to the subscriber traits in the subscriber data 287. The mapping data 289 can be based on the eligibility rules 285. The mapping data 289 can be user (e.g., system administrator) defined. For example, an eligibility rule 285 may be that subscribers 202A,B that have color-treated hair should receive products 235 that have attributes for color-treated hair. The mapping data 289 can map the subscribers 202A,B that have color-treated hair to the products 235 that have attributes for color-treated hair.

In another example, an eligibility rule 285 may be that subscribers 202A,B should not receive products 235 which they have previously received. The assortment and allocation module 265 can use historical data 291 that is stored in the data store 280 to determine which subscribers 202A,B have already received certain associated products 235. The historical data 291 can also be used to build predictive models of how subscribers 202A,B have reacted to (e.g. visited webpages, searched website) other similar products in the past. The assortment and allocation system 220 can include and/or be coupled to an application server that provides an application (e.g., web application, mobile application, etc.) to subscribers 202A,B for receiving input relating to products. The input can then be used to adjust and/or construct new eligibility rules.

The assortment and allocation module 265 can use the rules (e.g., business rules 281, quality rules 283, eligibility rules 285), mapping data 289, product data 245, subscriber data 287 and/or historical data 291 to assign groups 210 of products of one or more group types to the subscribers 202A,B. The assignment of groups 210 of products of one or more group types to subscribers 202A,B is hereinafter referred to as allocating and/or allocation.

The assortment and allocation module 265 can create an assortment that ensures each subscriber 202A,B is allocated to one of the group types. The assortment and allocation module 265 can create an optimal assortment and allocation of products based on one or more criteria, ensuring that in the allocation, for example, subscribers 202A,B receive only groups for which they are eligible. Examples of criteria can include, and are not limited to, determining a minimum number of group types, minimizing the difference in quality between the group types, maximizing conversions (e.g., sales of products), maximizing retention (e.g., subscriber retention), maximizing the sum of the subscriber feedback of products received, etc. The criteria can be represented by one or more constraints, which can be expressed by one or more rules. One implementation of creating an optimal assortment and allocation of products is described in greater detail below in conjunction with FIG. 3.

The assortment and allocation module 265 can generate assortment and allocation data 295 to describe an optimal assortment and allocation of products. The assortment data can include, for example, and is not limited to, the group type data 294 for the group types, the products that should be included for each group type, the number of instances to create for each group type, etc. The allocation data can include, and is not limited to, which group type the individual subscribers should receive. The assortment and allocation data 295 can be stored in the data store 280.

The assortment and allocation module 265 can provide the assortment and allocation data 295 to a system (e.g., packing system, distribution system, etc.). The system can use the assortment and allocation data 293 to provide a group 210 of products to the individual subscribers 202A,B. For example, a distribution system 230 may use the assortment data to package five hundred containers (e.g., boxes) that each contains products for Group-Type-1, three hundred boxes that each contains products for Group-Type-2, one hundred boxes that each contains products for Group-Type-3, etc. The distribution system 230 may use the allocation data to send the box that contains products for Group-Type-1 to Subscriber-1, the box that contains products for Group-Type-2 to Subscriber-54, the box that contains products for Group-Type-3 to Subscriber-48, etc. The assortment and allocation data 295 can also be stored as part of the historical data 291.

The distribution system 230 can include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to provide groups 210 of products to users (e.g., subscribers 202A,B).

The assortment and allocation module 265 can generate assortment and allocation data 295 periodically. The period can be pre-defined in configuration data 293 that is stored in the data store 280. For example, the configuration data 293 may specify that the assortment and allocation module 265 should generate assortment and allocation data 295 once a month. The configuration data 293 can be user (e.g., system administrator) defined. In one implementation, the assortment and allocation module 265 can generate assortment and allocation data 295 in response to a request, for example, from a user (e.g., system administrator) via a user interface, from a system (e.g., distribution system 230), etc.

In one implementation, the assortment and allocation module 265 reduces the time to determine an optimal configuration of group types using a sample of the subscriber base and/or a sample of data (e.g., subscriber data, product data, historical data, etc.). The configuration data 293 can include sampling criteria to create a sample of subscribers that is representative of the entire subscriber base.

The eligibility rules 285, mapping data 289, product data 245 and subscriber data 287 can be stored in one or more data stores 240,280, which the assortment and allocation module 265 can access, for example, via the network 250. The one or more data stores 240,280 can be memory (e.g., random access memory), cache, drives (e.g., hard drive), flash drives, database systems, or another type of component or device capable of storing data. The one or more data stores 240,280 may be mass storage devices, such as magnetic or optical storage based disks, solid-state drives (SSDs) or hard drives. In one implementation, the architecture 200 includes a distributed file system that may be a network attached storage file system that includes one or more machines and one or more data stores 240,280. The one or more data stores 240,280 can include multiple storage components (e.g., multiple drives or multiple databases) that may also span multiple computing devices (e.g., multiple server computers).

FIG. 3 is flow diagram of a method 300 for creating an optimal assortment of groups of items and allocating the groups of items to users, in accordance with one or more aspects of the present disclosure. The method may be performed by processing logic that may comprise hardware (circuitry, dedicated logic, etc.), software (such as is run on a general purpose computer system or a dedicated machine), or a combination of both. In one implementation, the method 300 may be performed by the assortment and allocation module 265 hosted in a server 260 in FIG. 2.

At block 301, the server determines an initial configuration of group types based on an initial set of constraints. The server can determine an initial configuration of group types for a collection of products for a set of users (e.g., subscriber base). The initial set of constraints can include, for example, and is not limited to, a minimum number of group types, the product inventory, the number of subscribers, the number of products for each group type, etc. Configuration data can specify the initial set of constraints. For example, the constraints may include (i) that every group instance meets certain rules and simultaneously, (ii) that every subscriber be allocated a group instance for which the subscriber is eligible. In one implementation, the server determines the initial configuration of group types using a mixed-linear linear program, which is the minimization or maximization of a linear function subject to linear constraints over integer variables.

For example, the server may determine that the initial configuration of group types includes four group types, and that each group type has five products. For example, the initial configuration of group types can define, for example, and is not limited to, the number of group types, the number of products in each group type, the product categories in each group type, the number of products for each product category in each group type, the product sub-categories in each group type, the number of products for each product sub-category in each group type, and/or the actual products in each group type. For example, Group-Type-1 may have two hair products for wavy hair, two skincare products oily skin, and one cosmetic product for eyes. Group-Type-2 may have one cosmetic product for lips, one skincare product for normal skin, one fragrance product for women, one nail product tagged as trendy, and one hair product for untreated hair.

The initial set of constraints can be represented by one or more rules (e.g., business rules, quality rules, eligibility rules). At block 303, the server applies one or more rules to the group types. At block 305, the server determines a solution for an optimal configuration of group types based on the constraints. The optimal configuration of group types can define, for example, and is not limited to, the number of group types, the number of products in each group type, the product categories in each group type, the number of products for each product category in each group type, the product sub-categories in each group type, the number of products for each product sub-category in each group type, and/or the actual products in each group type. The server can modify the initial set of constraints by modifying the rules pertaining to the initial set of constraints and/or the initial configuration of group types until there is a solution for an optimal configuration of group types. The determining of a solution for the optimal configuration of group types based on the constraints is described in greater detail below in conjunction with FIG. 4.

At block 307, the server creates and stores assortment data. The assortment data describes the configuration of group types where a solution exists for the set of constraints (e.g., modified set of constraints). The assortment data can include, for example, and is not limited to, the group types, the products that should be included for each group type, the number of instances to create for each group type, etc.

At block 309, the server allocates a group type to individual subscribers. The server can use the eligibility rules, the mapping data, the product inventory data, the subscriber data, and/or the historical data to assign the group types to the subscribers. The server can assign a group to a subscriber, where the group is of a group type that the subscriber is eligible to receive. At block 311, the server optimizes the allocations based on one or more optimization factors. Examples of optimization factors can include, and are not limited to, subscriber preferences, the probability that a subscriber is likely to purchase a version of a product, the probability that a subscriber will cancel a subscription, product data, etc.

For example, the server may determine from the subscriber data that Subscriber-1 prefers the color pink and may allocate Group-Type-1, which contains a pink nail polish product, to Subscriber-1. In another example, the server may determine that a particular color of lip gloss in Group-Type-13 is popular for a certain age group and may allocate Group-Type-13 to subscribers that fall within the certain age group. In one implementation, the server uses statistical analysis and predictive models to optimize the allocations. For example, the server may determine the probability that a subscriber is likely to purchase a version of a product and may use the information to allocate a group type to the subscriber. In another example, the server may determine the probability that a subscriber will cancel a subscription as a result of receiving a certain product and may use the information to prevent allocating a certain group type to the subscriber.

In one implementation, the server creates an eligibility matrix that includes representations of the optimization factors (e.g., subscriber preferences, probabilities, etc.). The server can determine extended-real values for the eligibility matrix for the optimization factors as scores. The scores can be derived from a statistical model including, and not limited to, historical data for previous assortments, domain knowledge (e.g., mapping data), purchase data, subscriber data, product data, etc. For each optimization factor, for a subscriber, the server may determine a summed score. A large summed score can indicate a positive outcome for the user. In the case that the overall allocation is solved using a linear program, the server can incorporate a constraint, expressed by one or more rules, into the mixed-integer linear program to maximize the summed score for each subscriber. For example, the server can build an assortment that can maximize the chance that a subscriber buys some or all of the products in the group type that is allocated to the subscriber. An infinite value in the eligibility matrix can represent the constraint that a certain subscriber must receive certain product.

At block 313, the server creates and stores allocation data that describes the allocations of the group types to the various subscribers. The allocation data can represent the “best” group for each subscriber subject to various predefined rules and statistical associations. At block 315, the server provides the assortment data and the allocation data to a system (e.g., distribution system, packaging system, etc.). The system can use the assortment data and the allocation data to provide a group instance (e.g., group of products) to the subscribers. For example, a distribution system may use the assortment data to create one hundred thousand group instances of products for Group-Type-1, fifty thousand group instances of products for Group-Type-2, twenty thousand group instances of products for Group-Type-3, etc. In one implementation, the group instances of products may be containers (e.g., boxes) that contain the actual products themselves. The distribution system may use the allocation data to provide the groups of products to the subscribers. For example, the distribution system may send the box that contains products for Group-Type-1 to Subscriber-1, etc. In one implementation, the instances of the groups of products may include links to products that are media items. The distribution system may use the allocation data to provide the groups of products to the subscribers. For example, the distribution system may send a notification (e.g., email message, text message, social media message, etc.) that contains links to the digital media products for Group-Type-1 to Subscriber-1, etc. For example, the distribution system may send an email message that contains a link to a recent episode of a children's television show and a link to a newly released children's book to Subscriber-1, etc.

At least a portion of method 300 can be iterative. The number of iterations can be based on a period. The server can generate assortment and allocation data periodically. The period can be pre-defined in configuration data. For example, the server may generate assortment and allocation data once a month. In one implementation, the server generates assortment and allocation data in response to a request, for example, from a user (e.g., system administrator) via a user interface, from a system (e.g., distribution system 230), etc. In another example, the number of iterations can be based on the number of constraints (e.g., rules).

FIG. 4 is flow diagram of a method 400 for determining a solution for an optimal configuration of group types based on constraints, in accordance with one or more aspects of the present disclosure. The method may be performed by processing logic that may comprise hardware (circuitry, dedicated logic, etc.), software (such as is run on a general purpose computer system or a dedicated machine), or a combination of both. In one implementation, the method 400 may be performed by the assortment and allocation module 265 hosted in a server 260 in FIG. 2.

At block 401, the server identifies a constraint to evaluate. For example, there may be two constraints. Constraint1 may be that each group type and/or group instance meets certain rules. Constraint2 may be that every subscriber be allocated a group instance for which the subscriber is eligible. The server may identify Constraint1 as a constraint to evaluate. At block 403, the server identifies a rule pertaining to the constraint. A constraint can be represented by one or more rules. Examples of rules can include, and are not limited to, business rules, quality rules, eligibility rules, etc. For example, for Constraint1, there may be two business rules that should be satisfied by the group types. For example, BusinessRule1 may be that each group type should contain at least one product sub-category that is different from the product sub-categories in the other group types. In another example, BusinessRule2 may be that each group type contains at most one hair product category and at most one skincare product category.

The server may identify, for example, BusinessRule1 at block 403. At block 405, the server determines whether the group types satisfy the identified rule (e.g., BusinessRule1). In one embodiment, the server uses the group type data to determine whether the group types satisfy a rule. In one embodiment, the group type data for a group type includes product attributes pertaining to product categories, product sub-categories, and products themselves specified for the corresponding group type. An example of a product attribute can include, and is not limited to, an attribute for product category. Examples of values for the product category attribute can include, and are not limited to, hair, skincare, makeup, nail, fragrance, etc. For example, the group type data for Group-Type-1 may include product attributes that define a group to include two hair products for color-treated hair, two skincare products for dry skin, and one cosmetic product for lips, a fragrance product for women, and a nail polish product. The server can evaluate the group type data for each of the group types to determine whether the rule is satisfied. If a group type satisfies a rule, the server can evaluate another group type until the server determines that the set of group types satisfy a rule or that there is at least one group type that does not satisfy the rule.

For example, the server may examine the product attributes in the group type data for each of Group-Type-1 to Group-Type-4 to determine whether BusinessRule1, which states that each group type should contain at least one product category that is different from the product categories in the other group types, is satisfied. For example, the server may determine from the group type data that Group-Type-1 contains a hair shampoo for color-treated hair, a cleanser skincare product for dry skin, a lip gloss makeup product, a women's fragrance product, and a blue nail polish product. The server may determine that there is at least one product sub-category in Group-Type-1 that is different from the product sub-categories in Group-Type-2, Group-Type-3, and Group-Type-4. The server may also determine that each of the four group types contain at least one product sub-category that is different from the product sub-categories in the other group types, and thus Business-Rule-1 is satisfied by the group types at block 405.

At block 415, the server determines whether there is another rule to evaluate for the constraint. The server can determine from configuration data whether there is another business rule, a quality rule, and/or eligibility rule that represents the constraint and can return to block 405 to apply the rule to the group types. For example, the server may determine that BusinessRule2 is part of the representation of Constraint1 and should be evaluated. If there is another rule to evaluate, the server returns to block 405 to determine whether the group types satisfy the rule (e.g., BusinessRule2). For example, the server may determine from the product attributes for Group-Type-1, which define a group to include two hair products for color-treated hair, two skincare products for dry skin, one cosmetic product for lips, a fragrance product for women, and a nail polish product, that Group-Type-1 does not satisfy BusinessRule2, which states that each group type contains at most one hair product and at most one skincare product.

If there is a group type that does not satisfy the rule (block 405), the server determines whether to modify or remove the current rule from the constraint at block 407. The server can modify and/or remove rules until a constraint is satisfied. For example, the server may change BusinessRule2 to each group type should contain at most two hair products and at most two skincare products. In another example, the server may remove BusinessRule2.

In one embodiment, the server determines whether to and/or how to modify a rule based on heuristics. A user (e.g., system administrator) may examine heuristics to determine why there is no solution and may use domain specific knowledge to provide user input of how the server should modify a rule. In one implementation, the removal of rules can be controlled by a configuration that expresses rule precedence. For example, each rule may be assigned a number, and the server may begin removing rules by removing the rule with the lowest number. The number may be user- (e.g., system administrator) defined and stored in a data store that is coupled to the server. The server may remove rules, for example, in order from the rule having the lowest number to the rule having the highest number. In another implementation, the server removes rules based on user input. A user (e.g., system administrator) may examine heuristics to determine why there is no solution and may use domain specific knowledge to provide user input of which rules the server should remove.

At block 411, the server determines whether to modify a group type, which is described in greater detail below. At block 415, the server determines whether there is another rule to evaluate for the constraint. The constraint (e.g., Constraint1) may be represented by one or more quality rules. For example, the server may determine that Constraint1 is also represented by QualityRule1, and returns to block 405 to determine whether the group types satisfy the rule (e.g., QualityRule1). QualityRule1 may be, for example, that the “best” group type and the “worst” group type have a minimal difference in quality scores. The minimal difference can be a configurable and/or user defined value. In one implementation, the best group type is the group type having the highest quality score, and the worst group type is the group type having the lowest quality score.

At block 405, the server determines whether the quality scores for the group types satisfy QualityRule1. The server can determine a quality score for each group type. The quality score can be based on product data of the products in the corresponding group type. For example, the quality scores can be based on the weight of the products, the cost of the products, the size-impression of the products, the user ratings of the products, etc. The group type quality scores may be any number, and/or value. For example, the group type quality score may be a numerical value from 0 to 1 (e.g., 0.8), where a value of 1 indicates that the group type is associated with high quality products. In another example, the group type quality score may be a numerical value from 1 to 10, or 1 to 100, where a higher number indicates that the group type is associated with high quality products. In one implementation, the server determines a scalar measuring quality of a product in a group type. The server can determine a vector of the scalars. The scalars of the products can be interpreted additively, and the server can determine the additive quality of the products in a group type as the sum of the quality score for the products in the group.

For example, the server may determine that the quality scores for the group types do not satisfy QualityRule1 (block 405), and then determines whether to modify and/or remove the rule (e.g., QualityRule1) at block 407. The server may determine from heuristics that quality rules should not be modified or removed and determines whether to modify one or more group types to satisfy the rule (e.g., QualityRule1) at block 411. The server can use heuristics to make the determination. For example, the server may determine from heuristics that one or more group type should be modified until a quality rule is satisfied. At block 413, the server modifies the configuration of one or more group types to satisfy QualityRule1. The modification can include adding and/or removing group types. For example, the server may minimize the difference between quality scores for the best group type and the worst group type by increasing the number of group types. For example, the server may determine that increasing the number of group types from four to seven minimizes the difference between the quality scores of the best group type and the worst group type to satisfy the quality rule. The server can use the rules (e.g., quality rules) to balance the quality of the group types with configuring the smallest number of group types.

At block 415, if there is not another rule to evaluate for the current constraint (e.g., Constraint1), the server determines whether there is another constraint to evaluate at block 417. For example, at block 417, the server may determine that there is Constraint2 that should be evaluated. Constraint2 may state that every subscriber should be allocated a group instance for which the subscriber is eligible.

The server returns to block 403 to identify a rule pertaining to Constraint2. For example, the server may determine that Constraint2 is represented by one or more eligibility rules. For example, Constraint2 may be represented by EligibilityRule1, which is that a subscriber is ineligible for a group type if that group type contains product categories and/or product sub-categories for which the subscriber is ineligible. For example, a subscriber is ineligible to receive a group type that contains a hair product for color-treated hair if the subscriber does not have color-treated hair. In another example, a subscriber is ineligible to receive a group type that contains a hair product that is not for color-treated hair if the subscriber does have color-treated hair.

At block 405, the server determines whether the rule (e.g., EligibilityRule1) is satisfied. The server can use product data, subscriber data, and mapping data to determine whether the rule is satisfied. The server can be coupled to one or more data stores that store product data that describes the product attributes for the products and subscriber data that describes the subscriber traits for the subscribers. The data stores can also store domain knowledge that maps product attributes to subscriber traits. The domain knowledge can be stored as mapping data (e.g., mapping data 289 in FIG. 2). In one implementation, the product attributes and subscriber traits are stored in binary format, and the server uses pseudo Boolean functions to encode and execute the rules (e.g., eligibility rules). The pseudo Boolean functions can be stored in a database. The database of pseudo Boolean functions can be extended over time. For example, the server may learn which constraints are effective from month to month. In one implementation, after the rules (e.g., eligibility rules) are encoded, for a given set of subscribers and products, the server can create an eligibility matrix that describes for example, and is not limited to, which subscribers are ineligible and/or eligible for which products, which subscribers are ineligible and/or eligible for which group types, etc.

If the rule (e.g., EligibilityRule1) is not satisfied (block 405), the server may determine to modify the configuration of group types to satisfy the eligibility rule at block 411, and may modify the group types at block 413. For example, the server may create two more group types, which increases the number of group types from seven to nine, and may change the actual products in the group types to satisfy the eligibility rule.

At block 415, the server determines whether there is another rule to evaluate for the constraint (e.g., Constraint2). If there is not another rule to evaluate, the server determines whether there is another constraint to evaluate at block 417. If there is not another constraint to evaluate (block 417), the server creates and stores assortment data. The assortment data describes the configuration of group types where a solution exists for a set of constraints. The assortment data can include, for example, and is not limited to, the group types, the products that should be included for each group type, the number of instances to create for each group type, etc.

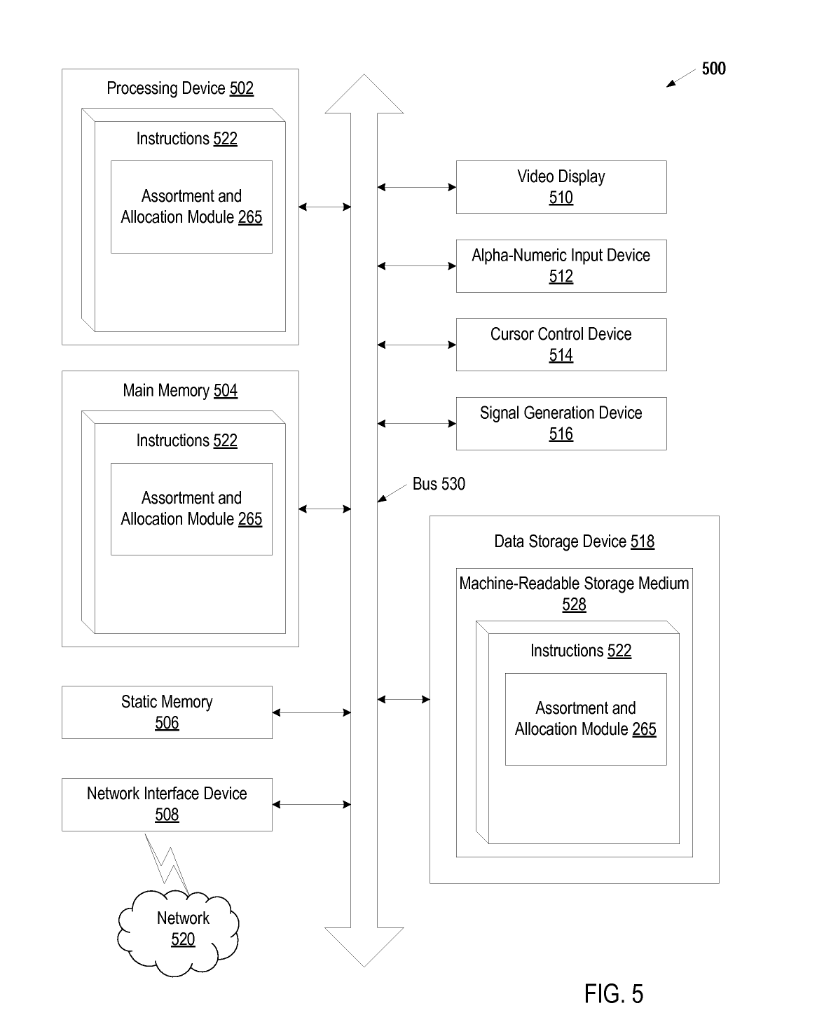

FIG. 5 illustrates a diagram of a machine in an example form of a computer system 400 within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processing device (processor) 502, a main memory 504 (e.g., read-only memory (ROM), flash memory, dynamic random access memory (DRAM) such as synchronous DRAM (SDRAM), double data rate (DDR SDRAM), or DRAM (RDRAM), etc.), a static memory 506 (e.g., flash memory, static random access memory (SRAM), etc.), and a data storage device 518, which communicate with each other via a bus 530.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 may also be one or more special-purpose processing devices such as an application specific integrated circuit (ASIC), a field programmable gate array (FPGA), a digital signal processor (DSP), network processor, or the like. The processor 502 is configured to execute instructions 522 for performing the operations and steps discussed herein.

The computer system 500 may further include a network interface device 508. The computer system 500 also may include a video display unit 510 (e.g., a liquid crystal display (LCD) or a cathode ray tube (CRT)), an input device 512 (e.g., a keyboard, and alphanumeric keyboard, a motion sensing input device, etc.), a cursor control device 514 (e.g., a mouse), and a signal generation device 516 (e.g., a speaker).

The data storage device 518 may include a computer-readable storage medium 528 on which is stored one or more sets of instructions 522 (e.g., software) embodying any one or more of the methodologies or functions described herein. The instructions 522 may also reside, completely or at least partially, within the main memory 504 and/or within the processor 502 during execution thereof by the computer system 500, the main memory 504 and the processor 502 also constituting computer-readable storage media. The instructions 522 may further be transmitted or received over a network 520 via the network interface device 508.

In one implementation, the instructions 522 include instructions for an assortment and allocation module (e.g., assortment and allocation module 265 in FIG. 2) and/or a software library containing methods that call the assortment and allocation module. While the computer-readable storage medium 528 (machine-readable storage medium) is shown in an exemplary implementation to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “modifying”, “allocating”, “providing”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

For simplicity of explanation, the methods are depicted and described herein as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Certain implementations of the present disclosure also relate to an apparatus for performing the operations herein. This apparatus may be constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one implementation” or “an implementation” means that a particular feature, structure, or characteristic described in connection with the implementation is included in at least one implementation. Thus, the appearances of the phrase “in one implementation” or “in an implementation” in various places throughout this specification are not necessarily all referring to the same implementation. In addition, the term “or” is intended to mean an inclusive “or” rather than an exclusive “or.” Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
determining an initial configuration of group types of items based on an initial set of constraints, wherein the initial set of constraints pertains to item data for the items and user data for a plurality of users;
modifying, by a server computer system, the initial configuration to satisfy one or more rules pertaining to the initial set of constraints to create an optimal configuration of group types, wherein the one or more rules comprises at least one rule pertaining to eligibility of individual users of the plurality of users to be assigned to one of the group types;
allocating one of the group types of the optimal configuration of group types to corresponding individual users of the plurality of users; and
providing data describing the optimal configuration of group types and the allocating of one of the group types to the corresponding individual users to a system.

2. The method of claim 1, wherein the allocating comprises:
assigning a group to the corresponding individual user, wherein the group is of a group type that the corresponding individual user is eligible to receive.

3. The method of claim 1, wherein the optimal configuration of group types defines at least one of a number of group types, a number of items in each group type, one or more item categories in each group type, or a number of items for each item category in each group type.

4. The method of claim 1, wherein the one or more rules further comprises at least one of business rules or quality rules.

5. The method of claim 1, wherein the items comprise a sample-sized version of a product.

6. The method of claim 1, wherein the plurality of users subscribes to a service that provides one or more of the items to subscribers of the service.

7. The method of claim 1, wherein the user data comprises data indicating one or more types of items that individual users are eligible to receive.

8. A system comprising:
a memory to store item data for a plurality of items and user data for a plurality of users; and
a processing device coupled with the memory to:
determine an initial configuration of group types of the items based on an initial set of constraints, wherein the initial set of constraints pertains to the item data and the user data;
modify the initial configuration to satisfy one or more rules pertaining to the initial set of constraints to create an optimal configuration of group types, wherein the one or more rules comprises at least one rule pertaining to eligibility of individual users of the plurality of users to be assigned to one of the group types;
allocate one of the group types of the optimal configuration of group types to corresponding individual users of the plurality of users; and
provide data describing the optimal configuration of group types and the allocating of one of the group types to the corresponding individual users to a system.

9. The system of claim 8, wherein to allocate comprises:
assigning a group to the corresponding individual user, wherein the group is of a group type that the corresponding individual user is eligible to receive.

10. The system of claim 8, wherein the optimal configuration of group types defines at least one of a number of group types, a number of items in each group type, one or more item categories in each group type, or a number of items for each item category in each group type.

11. The system of claim 8, wherein the one or more rules further comprises at least one of business rules or quality rules.

12. The system of claim 8, wherein the items comprise a sample-sized version of a product.

13. The system of claim 8, wherein the plurality of users subscribes to a service that provides one or more of the items to subscribers of the service.

14. The system of claim 8, wherein the user data comprises data indicating one or more types of items that individual users are eligible to receive.

15. A non-transitory computer readable storage medium encoding instructions thereon that, in response to execution by a processing device cause the processing device to perform operations comprising:
determining an initial configuration of group types of items based on an initial set of constraints, wherein the initial set of constraints pertains to item data for the items and user data for a plurality of users;
modifying, by the processing device, the initial configuration to satisfy one or more rules pertaining to the initial set of constraints to create an optimal configuration of group types, wherein the one or more rules comprises at least one rule pertaining to eligibility of individual users of the plurality of users to be assigned to one of the group types;
allocating one of the group types of the optimal configuration of group types to corresponding individual users of the plurality of users; and
providing data describing the optimal configuration of group types and the allocating of one of the group types to the corresponding individual users to a system.

16. The non-transitory computer readable storage medium of claim 15, wherein the allocating comprises:
assigning a group to the corresponding individual user, wherein the group is of a group type that the corresponding individual user is eligible to receive.

17. The non-transitory computer readable storage medium of claim 15, wherein the optimal configuration of group types defines at least one of a number of group types, a number of items in each group type, one or more item categories in each group type, or a number of items for each item category in each group type.

18. The non-transitory computer readable storage medium of claim 15, wherein the items comprises a sample-sized version of a product.

19. The non-transitory computer readable storage medium of claim 15, wherein the plurality of users subscribes to a service that provides one or more of the items to subscribers of the service.

20. The non-transitory computer readable storage medium of claim 15, wherein the user data comprises data indicating one or more types of items that individual users are eligible to receive.
